(19) United States
(12) Patent Application Publication
(10) Pub. No.: US 2004/0031415 A1
(43) Pub. Date: Feb. 19, 2004

(54) Activated silicon-containing-aluminum complex explosion-proof flame retardant and method for flame-proofing

(75) Inventors: Fred Bernat, Cliffside Park, NJ (US); Siqing Song-Destro, Norwalk, CT (US)

Correspondence Address: Siqing Song-Destro, 2 SOUTH END AVENUE SUITE 7K, NEW YORK, NY, 10280, US

(73) Assignee: BB Technology Consultants, Inc., Norwalk, CT (US)

(21) Appl. No.: 10/223,106

(22) Filed: Aug. 19, 2002

(51) Int. Cl. C09D 5/16; C09D 5/18; C09K 21/00

(52) U.S. Cl. 106/18.12; 252/601; 252/607

(57) ABSTRACT

An activated silicon-containing aluminum complex explosion and flame-proofing agent containing minor amounts of hydrogen, silicon, oxygen and hydrogen, the silicon being present in amounts of at least trace and having a hexagonal structure; the ratio oxygen and hydrogen in the complex usually being 16:18 and the process for making such complex comprises the steps of treating substantially pure aluminum with acid, then with mercury, then with a halogen acid again to form a slurry. The same slurry is then treated with liquid oxygen and changing the oxygen-hydrogen ratio to 20:18. The same slurry is then dried to crystalline form which, when diluted and added to flammable liquids, like alcohol, acetone, gasoline, petroleum-products, jet-fuel etc., make them explosion and flameproof. If diluted in the required proportion and applied on paper, paper pulp, cellulose pulp, plywood, clothing, textiles and any structurally porous material, it makes them flameproof.

### CROSS-REFERENCE TO RELATED APPLICATIONS

### RELATED U.S. APPLICATION DATA

| INT. CL. . . . | | |
|---|---|---|
| U.S. CL. . . . 427/372,2; 106/15,05; 106/18,12; 106/18,26; | | |
| 427/397,7; 427/439 | | |
| Field of search . . . 106/15.05 18,12; 18,26; 427/383,1; 397,7; 439 | | |
| References Cited - US Documents | | |
| 4,274,410 | January 1981 | Bernat . . . 252/305 |
| 4,277,355 | July 1981 | Farcnik . . . 106/15. |
| 4,382,025 | May 1983 | Sallay . . . 106/15. |
| 4,548,841 | September 1985 | Bernat . . . 427/439 |

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING

### COMPACT DISK APPENDIX

Not applicable

### BACKGROUND OF THE INVENTION

In the U.S. Pat. Ser. No. 810,103, it is stated that the structure of aluminum can be changed by chemical and electrochemical attack. The cylindrical or spherical shape of the silicon trace material was found to change to the hexagonal shape as a consequence of attack by the “free chlorine” of the slurry when such was applied to an ordinary aluminum foil. It is believed that the same change in structure occurs in the silicon particles contained in the aluminum particles suspended in the slurry due to the interaction of the mercury-treated aluminum with the hydrochloric acid solution. This change in structure which can be observed in the finished oxygenated solid fuel (U.S. Pat. No. 810,103) is also believed to be significant, i.e. furnishes some understanding of what has and does take place which enables the subject composition to function as a fuel-proofing agent.

It should be noted that when ordinary aluminum is introduced into an HCl solution, e.g. 1N or 2N, the production of aluminum Chloride (and water) occurs. However, the mercury-treated aluminum employed in this invention is a quite different creature. There is still the formation of AlCl₃ and other aluminum compounds as well, when such is immersed in the HCl solution. However, after the passage of from about 8 to 72 hours, a slurry is formed, starting as a faint white cloud. This is a consequence of a “growth” on the “treated” aluminum, which growth then “falls off” or “flakes off” into the acid bath and begins to form the slurry. After a passage of about 8 hours or so, the slurry is in full “bloom” and a discernible increase in viscosity begins to occur, leading to the preferred viscosity range of 20,000-22,000 cps.

In this slurry, a relatively small amount (weight-wise) of “activated aluminum growth particles” is suspended perhaps as a colloid. As stated previously, the percentage of the same is between about 0.7-1.0 to about 3.0-4.0 by weight. Theses “growth particles” however now contain entrapped therein because of their clathrate properties “free chlorine” (from the HCl), oxygen and hydrogen, probably in molecular or ionic form. The silicon of the aluminum has also been changed to the hexagonal structure.

Thus the slurry at least contains:

a) The reaction product of aluminum and hydrochloric acid in solution, e.g. Al***Cl—,H* and OH ions.

b) Free “activated aluminum” suspended probably colloidally, containing hexagonally structured silicon and also additionally containing traces of chlorine, hydrogen and oxygen entrapped therein.

The unusual properties of the slurry may possible also be explainable as a consequence of “Van Der Waal” forces of the well-known ability of particles in colloidal suspension to attract and retain on their surface dissolved substances and solvent molecules, i.e. to have molecules present in the solution even in ionic form become entrapped in or adhered on the particulate matter of the slurry or colloid. Whatever the explanation, the slurry is a critical medium for the explosion-proofing and for the fire-proofing.

Although the present invention has been described with references to particular embodiments and examples, it will be apparent to those skilled in the art that variations can be made.

### BRIEF SUMMARY OF THE INVENTION

The usefulness of the complex of the present invention will extend virtually to any application where such explosion proofing and flame proofing would be advantageous. The primary aim of this invention is to avoid explosions of flammable liquids, like in cars and airplanes. In addition, the complex of this invention will affect the fire proofing and/or insulation of building materials, textiles, carpets, paper products, and many other flammable products.

Moreover, the subject complex is non-polluting, nontoxic, and safe environmentally, having no adverse impact of any kind in the atmosphere and water. It is non-corrosive.

It is an object of the present invention to provide an activated silicon aluminum complex which is capable of releasing oxygen and hydrogen from an oxygen and hydrogen containing fluid.

Another object of the subject invention is to provide a unique slurry.

Still another object of the subject invention is to provide a method for the preparation of said silicon-aluminum complex including the preparation of the crystals.

Another object of this invention is to provide a method to apply the said crystalline solution to flammable and explosive liquids such as alcohol, acetone, gasoline jet fuel, petrol—distillates, etc., rendering them explosion-proof.

Another object of this invention is to provide a method to apply the said crystalline solution o n building materials, paper, paper pulp, cellulose pulp, plywood, rayon, clothes, textiles and other porous materials in order to rend them totally non-flammable—fireproof.

Still other objects will become apparent from the ensuing description and appended claims and drawings.

According to this invention, the activated aluminum complex consists essentially of aluminum and minor amounts of chlorine, activated hexagonally structured silicon, oxygen and hydrogen; the oxygen and hydrogen usually being present in atomic proportions of 16:18 or occasionally 14:16, 18:20 or mixtures thereof, being changed to an atomic proportion of 20:18; the sum of said chlorine, silicon, hydrogen and oxygen atoms not exceeding more than about 5 percent by weight of the aluminum atoms of said complex.

The complex can be prepared by the following sequence of steps:

1). Contacting aluminum metal having a purity preferably on the order of at least about 99.94% by weight, but including at least trace amount of silicon, with a source of acid of a type and concentration which will remove and inhibit the formation of oxide thereon; simultaneously, or thereafter, contacting said aluminum metal with mercury or less preferably a source of mercury in an oxygen-containing atmosphere.

2). Immersing said mercury-contacted aluminum in an acidic solution, containing halogen, to effect a slurry of particles of said mercury-contacted aluminum in said halogen-acidic solution, at a temperature of between ambient and not more than about 30° C.

3). Increasing the viscosity of the slurry up to between 20,000 cps, preferably closer to 22,000 cps.

4). Adjusting the pH of said slurry between 4.5 and 5.0.

5). Enriching said slurry with liquid oxygen, until it changes to crystalline structure.

6). Diluting said crystals in water to desired concentration.

7). Adding the said crystalline solution to the flammable liquids in the necessary proportion.

8). Immersing, or spraying said crystalline solution on the desired objects, provided that the said objects are provided with the desired capillarity.

9). Drying the prepared objects at ambient or any higher temperature. If the object is plywood, then the veneer surface should be pressed on the solution soaked pulp before the drying procedure.

### BRIEF DESCRIPTION OF THE SEVERAL VIEWS OF THE DRAWINGS

For a better understanding of the invention, reference will now be made to the accompanying drawings, wherein:

FIG. 1 is a schematic sectional elevational view of one embodiment of stage 1 of the process of the present invention.

FIG. 2 is a schematic view similar to FIG. 1, showing another optional embodiment of the stage 1 of the process of the present invention.

FIG. 3 is a schematic view similar to FIG. 1, showing the formation of the slurry in the HCL bath in the stage 2 of the process of the present invention. In this embodiment, the aluminum is disposed substantially equidistant from the sides and bottom of the vessel.

FIG. 4 is a depiction of the structure of the untreated, inactive silicon found in non-activated form in the aluminum.

FIG. 5 is a depiction of the hexagonal structure of the silicon of the complex formed in the stages two and three of the process of the present invention, in the slurry.

### DETAILED DESCRIPTION OF THE INVENTION

The activated-silicon containing aluminum complex of this invention can be conveniently prepared, utilizing a six stage process, although the process is not to be narrowly construed as being limited to such. The first stage, the preparation of a form of aluminum which can be termed “phase one” can typically be carried out as follows:

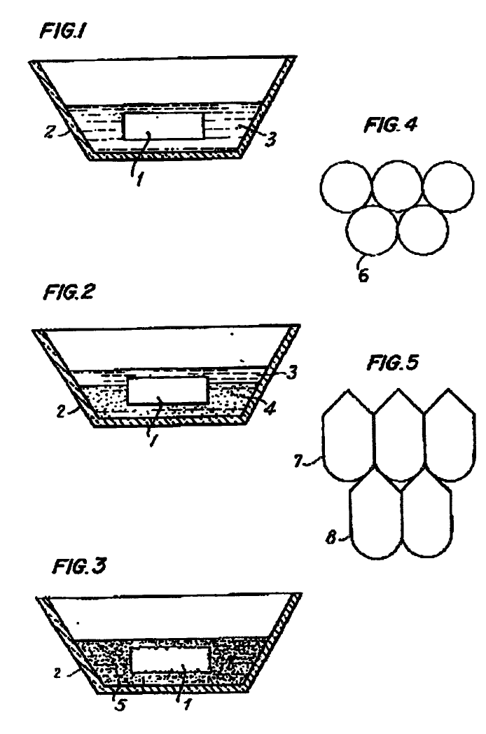

Utilizing the apparatus of FIG. 1, an aluminum bar or rod (1) is placed, as shown, in a vessel (2), the latter constructed from any acid resistant material, but preferably of glass, and a thin layer of hydrochloric acid (3) is placed thereover slightly, covering the aluminum. In this context, the shape of aluminum is not narrowly critical. However, a bar or rod shape is generally preferred. The purpose of the acid treatment is to inhibit the formation of oxide on the aluminum surface. Hydrochloric acid is usually the acid employed for this purpose.

It is further important that the aluminum be substantially pure, on the order of, but not limited, to about 99.94% pure and also contain amounts of silicon on the order of trade to about 60 ppm to about 150 ppm. As a practical matter, whether the aluminum is sufficiently pure can be empirically determined since, if there is an abrupt rise in temperature, this indicates oxide formation and that the aluminum starting material was not sufficiently pure. Therefore, for the purpose of this application, the term “substantially pure aluminum” denotes that degree of purity which is empirically determinable to be capable of being used in the process of this invention.

The aluminum is then contacted or coated with mercury or a source of mercury, preferably placing such in a bath of the same in a similar type of apparatus, in the presence of any oxygen-containing atmosphere, such as air. In either of these preliminary steps, the temperature is not narrowly critical, but should not be such as to encourage oxide formation and/or chlorine gas. Ambient temperature is satisfactory.

If desired, the acid and mercury contact can be made simultaneously, as shown in FIG. 2. In this figure, the aluminum (1) is immersed in the acid bath (3) and the heavier mercury bath (4), the HCL forming a layer on the bath of mercury.

Whether the apparatus on FIG. 1 or 2 or other suitable apparatus is used, the length of time of contact with the mercury can be minimal, on the order of between about fifteen and thirty seconds; longer contact however is not detrimental. Within the context of this invention, the mercury acts only as a catalyst, which effects a change in the aluminum structure. As indicated above, this changed structure is “phase one”.

The formation of “phase two” is the second stage in the process of this invention. This stage involves the formation of a slurry comprising phase one immersed in an acidic solution containing halogen. Particularly preferred among the suitable halogen solutions is hydrochloric acid.

The slurry can be formed in a number of ways and the method thereof is not critical in and of itself. For example after contact with the mercury bath, the thus treated aluminum rod or bar is then immersed in another vessel, containing a bath of HCL. The latter should have a normality of about 1 Normal to about 2 Normal, but the actual range of concentration is empirical. When phase one, which is soluble in HCL to some extent, is immersed in the acid solution, a rather viscous slurry, white in color, is formed. The slurry begins as a cloudy suspension and becomes increasingly dense. This is a consequence of particulate growth in and on the mercury-treated and activated aluminum rod or bar of phase one. This growth is shown in FIG. 3, wherein the thick slurry (5) is denoted as forming in the acid bath. As more and more particles form, the slurry becomes more and more viscous.

Depending on the size of the aluminum bar or the amount of HCL present, the formation of the slurry can continue up to the entire consummation of the phase one aluminum material. However as a practical matter, the reaction will usually stop before the aluminum bar is consumed completely because the slurry will become too dense for further growth to occur. At this point, the thick slurry thus formed can be removed, partly or completely; additional HCL is then added and slurry formation continued. As a practical matter, the viscosity of the slurry should be in the range of between 20,000 cps and 22,000 cps, preferably closer to 22,000 cps.

This slurry is “phase two”. In the formation thereof pursuant to the preparation of the complex, the temperature is important, that is between ambient and not more than about 30° C. and 25° C. It should be noted that a sudden adverse rise in temperature of the reaction environment at this point could again mean that the aluminum starting material was not sufficiently pure.

Alternatively, though less desirably, the slurry can also be made “in situ” in the embodiment represented by FIG. 2. As shown in FIG. 2, the aluminum bar or rod is covered by HCL but is also partly submerged in the source of mercury. Optionally, the HCL need not continue to cover the aluminum after oxide formation thereon is prevented or inhibited. A portion of the aluminum can be exposed above the surface. In either case, whether the HCL continues to cover the surface of the aluminum or not; a growth of some kind of complex occurs. This growth, itself, in this embodiment, is not the “phase two” slurry of this invention. The latter occurs in this “in situ” treatment, either when the particles of the “growth” “fall off” into the acidic portion of the HCL/Hg bath, or optionally after removing the complex growth (whether in the aluminum surface-exposed to air, or in that covered by acid) and immersing the same in a separate HCL bath to form the slurry as herein before described. In either case the sequence has been followed of treating an oxide-free aluminum with mercury to change the structure of the aluminum and to effect its activation, and then contacting or continuing to contact said aluminum with HCL to cause the “phase two” slurry formation.

In the slurry-forming step, it has been found useful, in order to avoid undesirable heat from occurring, to position the aluminum bar or rod substantially equidistant from the sides and bottom of the vessel, which is essentially the same as, or greater than the diameter of the bar or rod, a cylindrical rod shape being preferred. It is of course, possible to inhibit formation of undesirable heat without the above-indicated special relationships; in this event, the avoidance of oxides as a consequence of overheating would have to be constantly monitored. In this regard, for example, the treated bar could be constantly removed, re-washed, re-inserted and re-coated with mercury.

The phase two slurry is quite acidic with a pH level of between about 3 and about 4. It also contains both hydrogen, oxygen and chlorine atoms, probably in ionic form therein. The reason for this is that the phase one material has clathrate capabilities, i.e. it can entrap or confine the hydrogen, oxygen and chlorine ions within the particles of the slurry.

While the aforesaid temperature gradients are important when forming the slurry preparatory to the subsequent formation of the complex, it should be noted that the slurry itself can also be formed using somewhat higher temperatures, on the order of up to about 40° C. and also starting with aluminum of slightly less purity.

The next stage in the process of forming the complex, i.e., stage three, is to adjust the pH so that the chlorine defined within the said particles of the slurry becomes active; “active” meaning potentially unstable but not to the extent that the chlorine is liberated as chlorine gas. In this regard, it is desirable that the pH level of the slurry resides at a pH of about 4.5 and about 5.0. At this juncture, it could be noted that if the viscosity of the slurry is between about 20,000 cps and 22,000 cps, the pH is about 4.5 and 5.0. It is to be noted that at this point, the slurry will contain between about 1.5 to about 3.0% aluminum suspended therein in elemental form.

Less desirably, the increase or decrease of the pH is accomplished by treating the phase two material with a strong hydroxide such as NaOH or KOH in case of increase, and with HCL in case of decrease. The normality is not critical, but usually can be between about 2 and 3 Normal concentration. In either way, such a pH-adjusted slurry can be termed “phase three”.

The next stage in the process of forming the final complex, i.e., the “phase four”. It consists of treating the slurry or “phase three” with a flow of liquid oxygen. The same could be obtained by various methods but it is desirable that the same oxygen be bubbled from a liquid oxygen containing pressurized cylinder, through the slurry of “phase three”. The time of such a treatment is empirical, but usually is between about 3 and about 5 minutes. This process could be monitored by a gas-analyzer, like a Beckman or Bausch and Lomb instrument, but the method is empirical, because the forming of clear, transparent crystals are showing the accomplished saturation of the slurry of the phase three with oxygen. Thus, obtained crystals are termed “phase four” of this invention.

“Phase five” consist of solution or rather solutions of the crystals of “phase four”, after dissolving the said crystals in solvents such as water. While there is a whole array of solvents, potentially useful for the purpose, the use of water at ambient temperature is preferred.

The concentration, i.e., percentage of the crystals of the “phase four” in water or other solvents is empirical, because of the variety of the flammable liquids in order to be rendered explosion-proof, and also the flammable solid objects to be impregnated, and the respective capillarity. The range of the percentage of the crystals of the “phase four” in water, usually varies between about 3% and about 18%, depending of the explosion-potential of the flammable liquids, and also of the capillarity of the flammable solid objects. The total solids impregnated in the said objects are from about 0.7-1.0% to about 3.0-4.0%; thus the total “add on” weight on the treated solid objects is between about a minimum of 0.7% by weight to about 4.0% by weight. To be noted, that the “phase four” crystals consist from about 75% to about 80% of acidified waters in addition to aluminum, hydrogen, oxygen and chlorine. The same crystalline water is driven off during the drying process of the flameproof treated objects.

“Phase six” consists of selecting the flammable explosion inclined liquids and also the selecting of the solid flammable objects in order to be impregnated. While the range is enormous, we will mention some basic materials in everyday use. From liquids, all oil-distillates, including petroleum-ether, gasoline, kerosene, jet-fuel etc., other flammable liquids, like various alcohol, ethers, acetone etc., and a whole array of other flammable, easily evaporating liquids. From the solid objects to be mentioned: paper, paper pulp, cellulose pulp, plywood, clothing, carpets, textiles, building materials, etc. All of these materials have to be provided with sufficient capillarity-porosity in order to be able to absorb the solution of the “phase five”.

### EXAMPLE 1

Explosion Proofing

The dissolved liquid from the crystals of “phase four” and now named ”phase five” should be placed in a container or containers in the large tank which contains the explosive flammable liquid. The size of said container should be in proportion with the said liquid-containing tank, usually between about 1.0% and about 2.0% by volume of the liquid containing tank. The same container should be placed in the flammable-liquid tank in such a manner, as to be able when needed to be able to release the content of said container, either manually, automatically, or by impact. The released “phase five” liquid should conveniently expand in the whole area of the said flammable-liquid containing tank and inhibit the development of flame and the consequent explosion of the said flammable liquid. Conversely, in case of friction by impact, the same “phase five” liquid by being released and dispersed in the flammable liquid containing tank, should prevent and inhibit the explosion of said flammable liquid and prevent and inhibit of the possibility of consequently developing flame. The concentration of the crystals of “phase four” in aqueous solution of the “phase five” should be adjusted and proportioned according the explosion-potential of the said flammable liquid, usually between about 14% and about 18%. However, greater concentrations are not detrimental.

### EXAMPLE 2

Flame Proofing

a) Paper, carton or corrugated carton: the mentioned materials could be immersed in the liquid of the “phase five”, or sprayed on with, and then dried. Room temperature is sufficient, however any elevated temperature, in order to speed up the drying process would be acceptable. Depending on the paper's quality, and the way of application, the paper (or carton) could be also prepared to be strongly tension resistant and also to be almost transparent. Exposed to a normal flame, the paper and carton will char, without any flame or sparks, and without releasing any toxic or polluting substances in the atmosphere.

b) Paper pulp: the paper pulp should be immersed in the liquid of the “phase five”, squeezed under pressure and dried completely. Used as an insulator, between two flammable layers such as wooden wall or divider, the pulp becomes not only a heat-cold insulator, but also a fire protector on the layer opposite the one on which the fire starts.

c) Cellulose pulp: the cellulose pulp should be immersed in the liquid of “phase five”, squeezed under pressure, and while it is still wet, spread in a thin layer between two veneers of plywood while in production. Once the veneer is posted over the pulp, considerable pressure should be applied through callender rollers or similar methods. In a period between 12 and 18 hours, the capillary channels of the veneer will soak up the liquid of “phase five” from the pulp, rendering this way, fireproof not only the center layer, but also the whole plywood as such.

1. A composition for explosion-proofing and flame-proofing flammable articles comprising activated silicon containing aluminum particles prepared by the steps of:
a) contacting aluminum metal containing at least a trace amount of silicon with an acid of the type which will remove oxide coatings from and inhibit oxide formation thereon;
b) simultaneously or thereafter contacting said aluminum with mercury or a source of mercury;
c) immersing said mercury contacted aluminum metal in an acid bath at ambient temperature to not more than about 40° C., whereby particles are formed on the metal which on mixing with the acid bath form the slurry;
d) adjusting the pH of the slurry between 4.5 and 5.0;
e) enriching said slurry with a source of oxygen, until it changes to crystalline structure;

2. The composition according to claim 1), wherein the acid of steps a) and c) is HCI.

3. A method for explosion-proofing and flame-proofing flammable materials and articles which comprises:
a) contacting said materials and articles with a solution of crystals comprising activated silicon containing aluminum metal containing at least trace amounts of silicon with an acid of the type which will remove oxide and coatings from and inhibit oxide formation thereon; simultaneously or thereafter contacting said aluminum with mercury or a source of mercury; immersing said mercury contacted aluminum metal in an acid bath at ambient temperature to not more than about 40° C., whereby particles formed on the metal which on mixing with the acid bath form the slurry; adjusting the pH of said slurry to 4.5-5.0; and oxygenating said slurry to crystalline form.
b) drying the crystalline solution coated articles.

4. The method according to claim 3) wherein said materials are selected:
a) from the group consisting of gasoline, alcohol, petroleum derivatives, etc., and
b) from the group consisting of paper pulp, cellulose pulp, cardboard, etc.
